(19) United States
(12) Patent Application Publication
(10) Pub. No.: US 2024/0326678 A1
(43) Pub. Date: Oct. 3, 2024

(54) FOLDABLE HEATING APPARATUS

(71) Applicant: Rivian IP Holdings, LLC, Plymouth, MI (US)

(72) Inventors: Michal Jan Holcer, Mission Viejo, CA (US); Steve Gillette, Worthington (GB); Lindsey Michelle Cross, Dana Point, CA (US); Steven Digby Nicol, San Clemente, CA (US)

(21) Appl. No.: 18/193,924

(22) Filed: Mar. 31, 2023

(51) Int. Cl. B60N 3/16; F24C 7/08; F24C 15/10

(52) U.S. Cl. CPC B60N 3/16; F24C 7/083; F24C 15/103

(57) ABSTRACT

An apparatus that can include a heating surface, a configurable surface, and a hinge. The heating surface can be electrically couple with a power source. The hinge can couple with the heating surface and the configurable surface.

### INTRODUCTION

Vehicles can have batteries that can provide power to various components, replacing the use of power sources that release greenhouse gasses or contribute to greenhouse gas emissions.

### SUMMARY

This disclosure is generally directed to an apparatus. The apparatus can couple with a vehicle. For example, the apparatus can couple with a door, entry, liftgate, or a tailgate of the vehicle. The apparatus can decouple from the vehicle. The apparatus can include a heating surface, a configurable surface and a hinge. The heating surface can electrically couple with a power source. For example, the heating surface can electrically couple with a battery of an electric vehicle. The battery can provide power to the heating surface.

At least one aspect is directed to an apparatus. The apparatus can include a heating surface. The heating surface can be electrically coupled with a power source. The apparatus can also include a configurable surface. The apparatus can also include a hinge. The hinge can be coupled with the heating surface and the configurable surface.

At least one aspect is directed to an electric vehicle. The electric vehicle can include a heating surface. The heating surface can be electrically coupled with a battery of the electric vehicle. The electric vehicle can also include a configurable surface. The electric vehicle can also include a hinge. The hinge can be coupled with the heating surface and the configurable surface.

At least one aspect is directed to a method. The method can include providing a heating surface. The heating surface can be electrically coupled with a power source. The method can also include providing a configurable surface and a hinge. The method can also include assembling the hinge to couple with the heating surface and the configurable surface.

At least one aspect is directed to a method. The method can include providing an apparatus. The apparatus can include a heating surface. The heating surface can be electrically coupled with a power source. The apparatus can also include a configurable surface. The apparatus can also include a hinge. The hinge can be coupled with the heating surface and the configurable surface.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an electric vehicle.

FIG. 2 depicts a top view of an apparatus, in accordance with an implementation.

FIG. 3 depicts a rear view of the apparatus illustrated in FIG. 2, in accordance with an implementation.

FIG. 4 depicts a cross-sectional view of the vehicle illustrated in FIG. 1 and the apparatus illustrated in FIG. 2, in accordance with an implementation.

FIG. 5 depicts a view of the apparatus illustrated in FIG. 2, in accordance with an implementation.

FIG. 6 depicts an internal view of the apparatus illustrated in FIG. 2, in accordance with an implementation.

FIG. 7 depicts a bottom view of the apparatus illustrated in FIG. 2, in accordance with an implementation.

FIG. 8 depicts a bottom view of the apparatus illustrated in FIG. 2, in accordance with an implementation.

FIG. 9 depicts a side view of the vehicle illustrated in FIG. 1 and the apparatus illustrated in FIG. 2, in accordance with an implementation.

FIG. 10 depicts a bottom view of the apparatus illustrated in FIG. 2, in accordance with an implementation.

FIG. 11 depicts a bottom view of the apparatus illustrated in FIG. 2, in accordance with an implementation.

FIG. 12 depicts a bottom view of the apparatus illustrated in FIG. 2, in accordance with an implementation.

FIG. 13 depicts a side cross-sectional view of the apparatus illustrated in FIG. 2, in accordance with an implementation.

FIG. 14 depicts a top view of the apparatus illustrated in FIG. 2, in accordance with an implementation.

FIG. 15 depicts a side view of the apparatus illustrated in FIG. 2, in accordance with an implementation.

FIG. 16 depicts a cross-sectional view of the apparatus illustrated in FIG. 2, in accordance with an implementation.

FIG. 17 depicts a cross-sectional view of the apparatus illustrated in FIG. 2, in accordance with an implementation.

FIG. 18 depicts a top view of the apparatus illustrated in FIG. 2, in accordance with an implementation.

FIG. 19 depicts a top view of the apparatus illustrated in FIG. 2, in accordance with an implementation.

FIG. 20 depicts a rear view of the vehicle illustrated in FIG. 1 including the apparatus illustrated in FIG. 2, in accordance with an implementation.

FIG. 21 depicts a rear view of the vehicle illustrated in FIG. 1 including the apparatus illustrated in FIG. 2, in accordance with an implementation.

FIG. 22 depicts a rear view of a vehicle including the apparatus illustrated in FIG. 2, in accordance with an implementation.

FIG. 23 depicts a rear view of the vehicle illustrated in FIG. 22 including the apparatus illustrated in FIG. 2, in accordance with an implementation.

FIG. 24 depicts a rear view of the vehicle illustrated in FIG. 22 including the apparatus illustrated in FIG. 2, in accordance with an implementation.

FIG. 25 depicts a rear view of the vehicle illustrated in FIG. 22 including the apparatus illustrated in FIG. 2, in accordance with an implementation.

FIG. 26 depicts an internal view of the vehicle illustrated in FIG. 22 including the apparatus illustrated in FIG. 2, in accordance with an implementation.

FIG. 27 depicts an example system to control an apparatus, in accordance with an implementation.

FIG. 28 depicts an example flow diagram of a process of manufacturing an apparatus, in accordance with an implementation.

FIG. 29 depicts an example flow diagram of a process to provide an apparatus, in accordance with an implementation.

FIG. 30 is a block diagram illustrating an architecture for a computer system that can be employed to implement elements of the systems and methods described and illustrated herein.

### DETAILED DESCRIPTION

Following below are more detailed descriptions of various concepts related to, and implementations of, methods, apparatuses, and systems of an apparatus including at least one heating surface, at least one configurable surface, and at least one hinge. The apparatus of the present disclosure can receive power from batteries used to power electric vehicles. The apparatus can reduce greenhouse gas emissions by replacing greenhouse gas emitting power sources with the batteries used to power electric vehicles. The various concepts introduced above and discussed in greater detail below may be implemented in any of numerous ways.

The present disclosure is directed to systems and methods of providing an apparatus. The apparatus can include a heating surface. The heating surface can be electrically coupled with a power source. The apparatus can include a configurable surface. The configurable surface can have at least one functionality. For example, the configurable surface can be or include a cutting board. The functionality of the configurable surface can be adjusted, modified, altered or changed. For example, the cutting board included in the configurable surface can be removed. The removal of the cutting board can provide an opening for a new component. For example, the opening can receive a sink. The addition of the sink and the removal of the cutting board can adjust the functionality of the configurable surface. The apparatus can include a hinge. The hinge can be coupled with the heating surface and the configurable surface. The hinge can fold the heating surface over the configurable surface and the hinge can fold the configurable surface over the heating surface.

Systems and methods of the present technical solution can provide an apparatus that can have at least one configuration and the apparatus can couple and decouple from a vehicle. For example, the apparatus can have a first configuration and a second configuration. The apparatus can be coupled with the vehicle in the first configuration and the apparatus can be decoupled from the vehicle. The configuration of the apparatus can be or include at least one of a position, an orientation, a layout or an arrangement. The first configuration can be at least one of an open position, an accessible position, a cooking position, a deployed position, an operable position or a functional position. For example, the heating surface can be accessible with the apparatus in the first configuration. The second configuration can be at least one of a closed position, a stowed position, a folded position, a storage position or an inaccessible position. For example, the heating surface can be folded over the configurable surface and the heating surface can be inaccessible with the apparatus in the second configuration. The apparatus can be, responsive to being placed in the second configuration, stored within an internal portion of the vehicle. For example, the apparatus can be stored in the loadfloor of the vehicle.

The disclosed solutions have a technical advantage of providing an apparatus that has a first configuration and a second configuration. The apparatus having a first configuration and a second configuration enables the apparatus to occupy minimal space during times of inactivity while also providing a simplistic setup process. For example, the apparatus can easily adjust from the second configuration to the first configuration. The case of adjusting the configuration of the apparatus simplifies the setup process and the storage process of the apparatus.

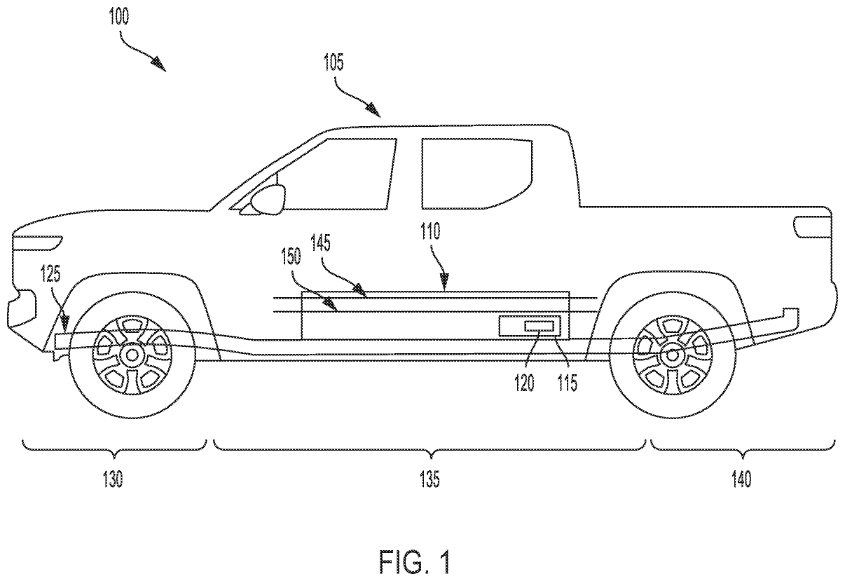

FIG. 1 depicts an example cross-sectional view 100 of an electric vehicle 105 installed with at least one battery pack 110. Electric vehicles 105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 110 can also be used as an energy storage system to power a building, such as a residential home or commercial building. Electric vehicles 105 can be fully electric or partially electric (e.g., plug-in hybrid) and further, electric vehicles 105 can be fully autonomous, partially autonomous, or unmanned. Electric vehicles 105 can also be human operated or non-autonomous. Electric vehicles 105 such as electric trucks or automobiles can include on-board battery packs 110, batteries 115 or battery modules 115, or battery cells 120 to power the electric vehicles. The electric vehicle 105 can include a chassis 125 (e.g., a frame, internal frame, or support structure). The chassis 125 can support various components of the electric vehicle 105. The chassis 125 can span a front portion 130 (e.g., a hood or bonnet portion), a body portion 135, and a rear portion 140 (e.g., a trunk, payload, or boot portion) of the electric vehicle 105. The battery pack 110 can be installed or placed within the electric vehicle 105. For example, the battery pack 110 can be installed on the chassis 125 of the electric vehicle 105 within one or more of the front portion 130, the body portion 135, or the rear portion 140. The battery pack 110 can include or connect with at least one busbar, e.g., a current collector element. For example, the first busbar 145 and the second busbar 150 can include electrically conductive material to connect or otherwise electrically couple the battery 115, the battery modules 115, or the battery cells 120 with other electrical components of the electric vehicle 105 to provide electrical power to various systems or components of the electric vehicle 105.

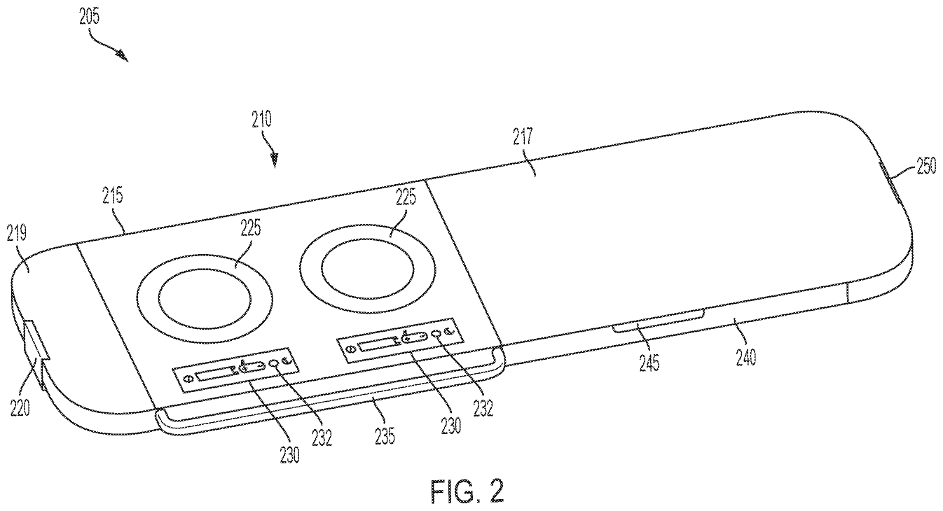

FIG. 2 depicts a top view of an apparatus 205, in accordance with an implementation. The apparatus 205 can include at least one cooking module 210, at least one heating surface 215, at least one configurable surface 217, at least one handle 235 and at least one compartment 240. The apparatus 205 can have at least one configuration. For example, the apparatus can have a first configuration and a second configuration. The configuration of the apparatus 205 can be or include at least one of a placement, a position, an orientation, a layout or an arrangement. The first configuration of the apparatus 205 can be at least one of an open position, an accessible position, a cooking position, a deployed position, an operable position or a functional position. For example, the heating surface 215 can be accessible with the apparatus 205 in the first configuration. The second configuration of the apparatus 205 can be at least one of a closed position, a stowed position, a folded position, a storage position or an inaccessible position. For example, an operator of the apparatus 205 can fold the heating surface 215 with the configurable surface 217 and the heating surface 215 can be inaccessible with the apparatus 205 in the second configuration. The apparatus can be placed in the second configuration responsive to the hinge folding the heating surface 215 with the configurable surface 217. The apparatus 205 can be, responsive to operator of the apparatus 205 adjusting the apparatus 205 from the first configuration to the second configuration, stored, placed, stowed or otherwise located with the vehicle 105. For example, the apparatus 205 can be placed in a loadfloor of the vehicle 105. FIG. 2 depicts an example of the apparatus 205 in the first configuration.

The cooking module 210 can be mounted, placed, secured, attached or otherwise coupled with a vehicle. For example, the cooking module 210 can couple with the vehicle 105. The cooking module 210 can couple with a tailgate of the vehicle 105. The cooking module 210 can decouple from the tailgate of the vehicle 105. For example, the cooking module 210 can be removed, detached, unsecured or otherwise separated from the vehicle 105 or the tailgate. The cooking module 210 can also be placed, located, positioned or otherwise set on an object. For example, the cooking module 210 can be placed on at least one of a table, a bench, a ground surface, a chair or a desk. The cooking module 210 can include or house at least one of the heating surface 215 or the configurable surface 217. For example, the cooking module 210 can define a body of the apparatus 205 and the body can contain, hold, or otherwise house the heating surface 215 and the configurable surface 217. The cooking module 210 can be electrically coupled with a power source. For example, the cooking module 210 can be electrically coupled with the battery 115 of the vehicle 105. The cooking module 210 can also electrically decouple from the battery 115 of the vehicle 105.

The heating surface 215 can be or include at least one of a cooking surface, a thermal surface, a stove top or a cooktop. The heating surface 215 can be electrically coupled with a power source. The power source can be a battery of an electric vehicle. For example, the heating surface 215 can be electrically coupled with the battery 115 of the vehicle 105. The battery 115 can provide power to the heating surface 215 or a component thereof. The heating surface 215 can operate with the cooking module 210 coupled with the vehicle 105. For example, the heating surface 215 can operate when the cooking module 210 is coupled with a tailgate of the vehicle 105. The heating surface 215 can operate with the cooking module 210 decoupled from the vehicle 105. For example, the heating surface 215 can operate with the cooking module 210 placed on a ground surface or a table. The heating surface 215 can include at least one heating element 225. The heating element 225 can heat at least a portion of the heating surface 215. The heating element 225 can heat the heating surface 215 by producing heat. The heat produced by the heating element 225 can result in the temperature of the heating surface 215 increasing. The heating element 225 can produce heat by at least one of induction heat, conduction heat, convection heat or radiant heat. For example, the heating element 225 can be or include coils that are placed, located or otherwise positioned on, throughout or within the heating surface 215. The heating element 225 can receive power from the battery 115. The heating element 225 can consume, from the battery 115, current and the heating element 225 can produce heat responsive to the current flowing through the heating element 225. The amount of power provided by the battery 115 or the amount of current that flows through the heating element 225 can control the amount of heat that is produced by the heating element 225.

The heating surface 215 can include at least one adjusting module 230. The adjusting module 230 can be at least one of an input device, an adjusting mechanism, an input element or an input unit. The adjusting module 230 can be electrically coupled with the heating element 225. The adjusting module 230 can adjust an amount of heat that is produced by the heating element 225. For example, the adjusting module 230 can adjust the amount of heat produced by the heating element 225 by adjusting the amount of current that flows through the heating element 225. The adjusting module 230 can be or include at least one capacitive touch button. The adjusting module 230 can include at least one optical indicator 232. The optical indicator 232 can provide an indication of a temperature of the heating surface 215. The optical indicator 232 can be or include at least one of a screen, a display screen or a light source. For example, the optical indicator 232 can be a liquid crystal display (LCD) and the LCD can produce, provide, display or otherwise present the temperature of the heating surface 215. The heating surface 215 can have a first portion and a second portion. The first portion can include the heating elements 225, the adjusting modules 230 and the optical indicators 232. The second portion can include at least one auxiliary surface 219. The auxiliary surface 219 can be or include at least one of a countertop, a table top, a cutting board or a horizontal surface.

The apparatus 205 can include at least one latch 220. The latch 220 can be mounted, placed, secured, attached or otherwise coupled with heating surface 215. The latch 220 can mount, place, secure, attach or otherwise couple the heating surface 215 with the configurable surface 217 responsive to the heating surface 215 being folded with the configurable surface 217. For example, the latch 220 can couple the heating surface 215 with the configurable surface 217 by locking, holding or otherwise maintaining the apparatus 205 in the second configuration (e.g., folded position). The latch 220 can be or include at least one of a groove, a divot, a clasp, a clip or a fastener. The latch 220 can have at least one resting position (e.g., the position of the latch 220 while not coupling the heating surface 215 with the configurable surface 217) and at least one coupled position (e.g., the position of the latch 220 while coupling the heating surface 215 with the configurable surface 217).

The configurable surface 217 can be or include at least one of a cutting board, a countertop, a horizontal surface, a tabletop, a bar, a work top, a landing space or a sink. FIG. 2 depicts an example of the configurable surface 217 as a countertop. At least a portion of the configurable surface 217 can be adjusted, modified, altered, customized or otherwise changed. For example, the portion of the configurable surface 217 that includes a cutting board can be removed and replaced with a sink. The configurable surface 217 or a portion thereof can be made with or include sustainability materials. For example, the configurable surface 217 can be made of recycled polymer material (e.g., plastic).

The configurable surface 217 can include at least one notch 250. The notch 250 can be shaped, designed, orientated, arranged, composed or otherwise formed to interface with, interact with or engaged with the latch 220. The notch 250 can be or include at least one of an indent, a grove, a slot or a slit. The latch 220 can interact with, interface with or otherwise engage with the notch 250. For example, the latch 220 can make contact with the notch 250. The latch 220 can be mounted, placed, secured, attached or otherwise coupled with the notch 250. The latch 220 can, responsive to the latch 220 coupling with the notch 250, couple the heating surface 215 with the configurable surface 217.

The handle 235 can be mounted, placed, secured, attached or otherwise coupled with the heating surface 215. The handle 235 can be or include at least one hinge. The handle 235 can have at least one position and the handle 235 can move from or to one or more positions. For example, the handle 235 can have at least one stowed position and at least one deployed position. The stowed position can be a position disposed within or beneath the heating surface 215. The deployed position can be a position disposed external to the heating surface 215. The handle 235 can move, adjust, swing, pivot or otherwise change from the stowed position to the deployed position. The handle 235 can move, adjust, swing, pivot or otherwise change from the deployed position to the stowed position. For example, an operator of the apparatus 205 or the handle 235 can, responsive to interacting with, engaging with or otherwise making contact with at least a portion of the handle 235, move the handle 235 from the stowed position to the deployed position. FIG. 2 depicts an example of the handle 235 in the deployed position.

The handle 235 can be or include at least one of a railing, a bar, a pole, a beam or a shaft. The handle 235 can hold at least one component or object. For example, the handle 235 can hold a hand towel. The handle 235 can hold the objects by providing a structure that can receive the objects and also support the objects. The handle 235 can provide, with the handle 235 in the deployed position, an opening between the apparatus 205 or a component thereof and an outer portion of the handle 235. The opening provided by the handle 235 can allow for the objects to be placed, secured, received or held by the handle 235.

The compartment 240 can be mounted, placed, secured, attached or otherwise coupled with the configurable surface 217. The compartment 240 can be at least one of a drawer, a cupboard or a tray. The compartment 240 can store a component. The component can be at least one of a cooking utensil (e.g., a spatula, tongs, a whisk, measuring spoons, and scissors), a piece of flatware (e.g., a spoon, a fork, and a knife), a cutting board, a dish (e.g., a plate, bowl), a food thermometer, a cooking timer or a light (e.g., a flashlight). The compartment 240 can have at least one position. For example, the component can have a first position and a second position. The compartment 240 can slide, glide, move, or otherwise adjust from the first position to the second position or from the second position to the first position. The compartment 240 can be disposed beneath the configurable surface 217 with the compartment 240 in the first position. The first position can be a closed position. At least a portion of the compartment 240 can extend beyond the configurable surface 217 with the compartment 204 in the second position. The second position can be an open position. The component stored by the compartment 240 can be accessible with the compartment 240 in the second position.

The compartment 240 can have at least one handle 245. An operator of the apparatus 205 or the compartment 240 can interact with, interface with, engage with or otherwise use the handle 245 to open (e.g., move the compartment 240 from the first position to the second position) or close (e.g., move the compartment 240 from the second position to the first position) the compartment 240. For example, the operator of the compartment 240 can, using the handle 245, open the compartment 240 and retrieve the component stored by the compartment 240.

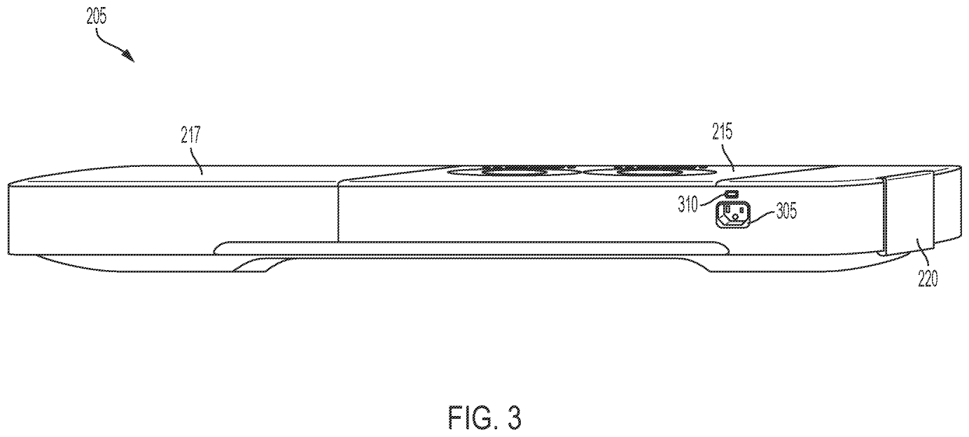

FIG. 3 depicts a rear view of the apparatus 205, in accordance with an implementation. The apparatus 205 can include at least one power cord 305 and at least one port 310. The power cord 305 can be electrically coupled with a power source. For example, the power cord 305 can be electrically coupled, via an outlet, with the vehicle 105 or the battery 115. The battery 115 can provide power, via the power cord 305, to the apparatus 205 or a component thereof. For example, the battery 115 can provide power to the heating surface 215. The power cord 305 can have at least one stowed position and at least one deployed position. For example, the power cord 305 can retracted into the apparatus 205 (e.g., the stowed position). FIG. 2 depicts an example of the power cord 305 retracted into the apparatus 205. The power cord 305 can be retracted into the apparatus 205 by at least one of moving, adjusting, disposing, positioning or locating the power cord 305 from a position that is external the apparatus 205 to a position that is within the apparatus 205. The power cord 305 can be deployed from the apparatus 205 by moving, adjusting, positioning or locating the power cord 305 from a position that is within the apparatus 205 to a position that is external to the apparatus 205. The power cord 305 can be enclosed, responsive to having been retracted within the apparatus 205, by a cover. The enclosing of the power cord 305 can prevent debris (e.g., dirt, sand, mud) or water from reaching the power cord 305.

The port 310 can receive, accept, connect with, engage with, interface with, interact with or otherwise electrically couple with at least one of a Universal Serial Bus (USB) cable, a device connector cable, a device charging cable or a device receiver (e.g., a Bluetooth receiver, a wireless receiver). For example, the port 310 can receive and electrically couple with a USB-C cable. The port 310 can provide power to a device that is electrically coupled, via the USB-C cable, with the port 310. The port 310 can provide power to the device. The device can be at least one of a mobile phone, a tablet, a laptop, a speaker, a wearable device or an electric utensil. For example, the device can be an electric knife and the port 310 can provide power to the electric knife.

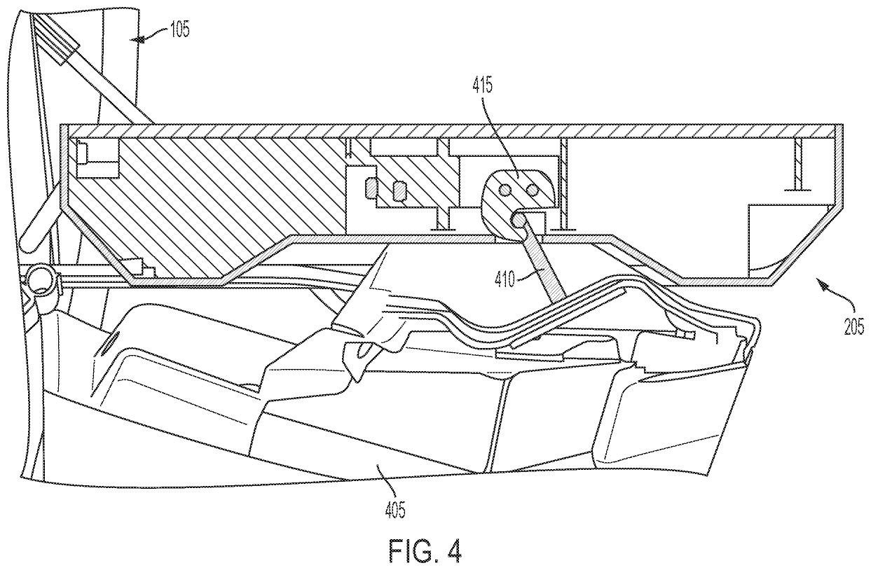

FIG. 4 depicts a cross-sectional view of the vehicle 105 and the apparatus 205, in accordance with an implementation. The vehicle 105 can include at least one door 405. The door 405 can be at least one of a door, an entry, a trunk, a tailgate or a liftgate. FIG. 4 depicts the door 405 as a tailgate of a truck. The door 405 can include at least one latch 410. The latch 410 can protrude, stick out or otherwise extend outside of the door 405. The door 405 can include at least one opening that provides an area for the latch 410 to extend outside of the door 405. The latch 410 can also be positioned within the door 405. For example, the latch 410 can be disposed within the door 405 and an operator of the apparatus 205 or the vehicle 105 can engage with, interact with, interface with or otherwise grab the latch 410 and move the latch 410 from within the door 405 to a position where the latch 410 extends beyond the door 405. The apparatus 205 can be mounted, placed, secured, attached or otherwise coupled with the latch 410. The latch 410 can receive, accept or otherwise engage with the apparatus 205. For example, the latch 410 can provide a contact point that the apparatus 205 can then couple with. The apparatus 205 can include at least one hook 415. The hook 415 can be mounted, placed, secured, attached or otherwise coupled with the latch 410. For example, the hook 415 can engage with and clasp the latch 410. The hook 415 can couple the apparatus 205 with the vehicle 105 responsive to the hook 415 engaging with the latch 410. FIG. 4 depicts an example of the hook 415 coupled with the latch 410.

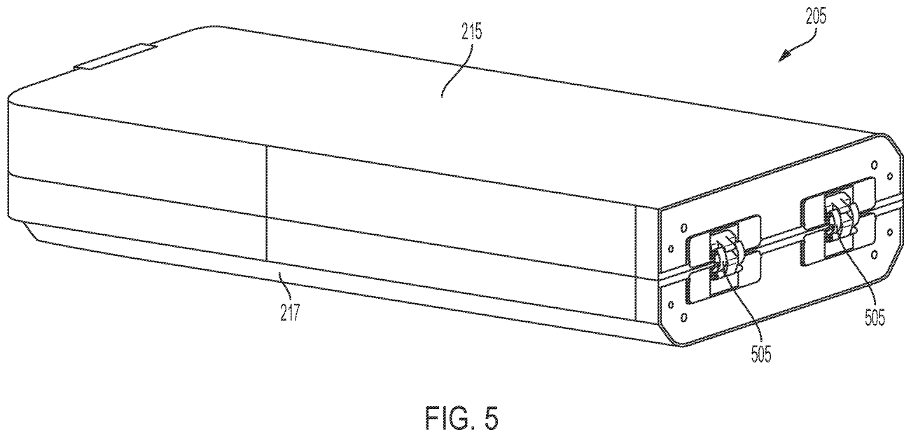

FIG. 5 depicts a view of the apparatus 205, in accordance with an implementation. The apparatus 205 can include at least one hinge 505. The hinge 505 can be mounted, placed, secured, attached or otherwise couple with the heating surface 215 and the configurable surface 217. The hinge 505 can pivot, spin, rotate, adjust, move or otherwise fold the heating surface 215 with the configurable surface 217. The hinge 505 can also fold the heating surface 215 over the configurable surface 217 and fold the configurable surface 217 over the heating surface 215. For example, an operator of the apparatus 205 can engage with, interact with, interface with or otherwise grab at least one of the heating surface 215 or the configurable surface 217 and fold, via the hinge 505, the heating surface 215 with the configurable surface 217. FIG. 5 depicts an example of the heating surface 215 folded with the configurable surface 217, and an example of the apparatus 205 having been placed in the second configuration (e.g., the folded position) responsive to the operator folding, via the hinge 505, the heating surface 215 with the configurable surface 217.

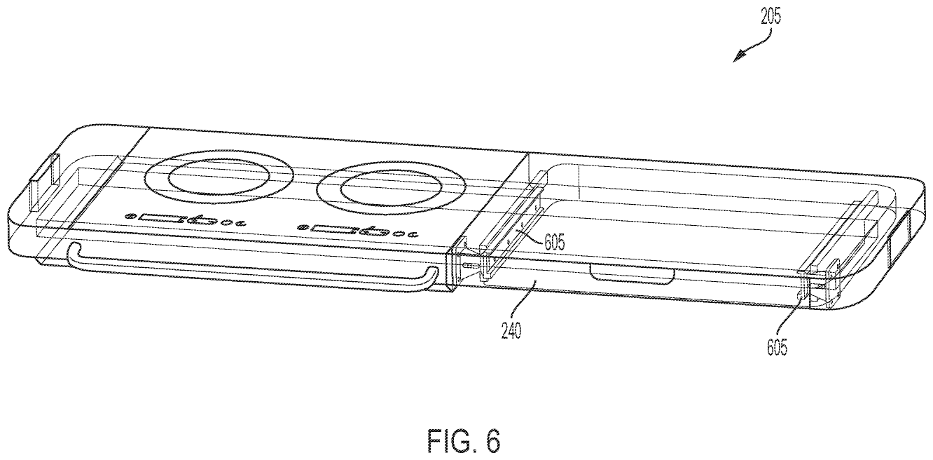

FIG. 6 depicts an internal view of the apparatus 205, in accordance with an implementation. The compartment 240 can include at least one railing 605. The railing 605 can be mounted, placed, secured, attached or otherwise coupled with the cooking module 210. The railing 605 can move, slide, glide or otherwise adjust the position of the compartment 240. For example, the railing 605 can adjust the compartment 240 from a position within the apparatus 205 (e.g., the first position) to a position where at least portion of the compartment 240 extends beyond the configurable surface 217 (e.g., the second position). FIG. 6 depicts an example of the compartment 240 in the first position as the compartment 240 is disposed beneath the configurable surface 217.

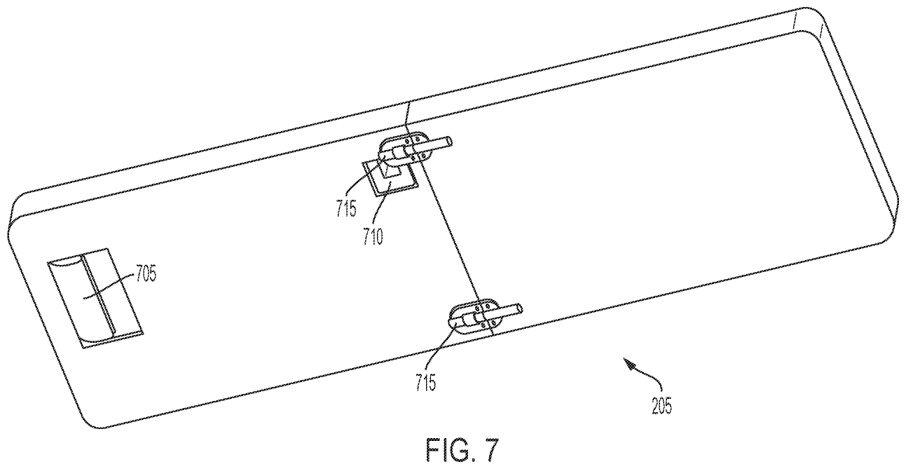

FIG. 7 depicts a bottom view of the apparatus 205, in accordance with an implementation. The apparatus 205 can include at least one opening 705, at least one supporting module 710 and at least one locking mechanism 715. The opening 705 can be positioned, placed, deposed or otherwise located within the cooking module 210 and beneath at least one of the heating surface 215 or the configurable surface 217. The opening 705 can provide access to hook 415. An operator of the apparatus 205 can interact with, interface with, engage with or otherwise grab the opening 705 by making contact with at least one of an indent, a handle, a depression or notch included with the opening 705.

The supporting module 710 can be positioned, placed, deposed or otherwise located within the cooking module 210 and beneath at least one of the heating surface 215 or the configurable surface 217. The supporting module 710 can rest on a door or tailgate of a vehicle. For example, the supporting module 710 can rest on the door 405 of the vehicle 105. The supporting module 710 can have at least one stowed position and at least one deployed position. The stowed position can be a position where the supporting module 710 is located, placed or otherwise positioned within the cooking module 210. The deployed position can be a position where the supporting module 710 extends, protrudes, reaches or otherwise sticks out beyond a portion of the cooking module 210. The supporting module 710 can rotate, adjust, swivel, pivot, hinge or otherwise move from the stowed position to the deployed position. FIG. 7 depicts an example of the supporting module 710 in the stowed position. The supporting module 710 can support at least a portion of the apparatus 205. The supporting module 710 resting on the door 405 can support the apparatus 205. The supporting module 710, responsive to resting on the door 405, can support the apparatus 205 by at least one of holding, reinforcing, propping, stabilizing or bracing the apparatus 205.

The locking mechanism 715 can hold, maintain, keep or otherwise lock the apparatus 205 in the first configuration. For example, the locking mechanism 715 can prevent an operator of the apparatus 205 from folding the heating surface 215 over the configurable surface 217 and from folding the configurable surface 217 over the heating surface 215. The locking mechanism 715 can be or include at least one of a bolt, a latch, a clasp or a pin.

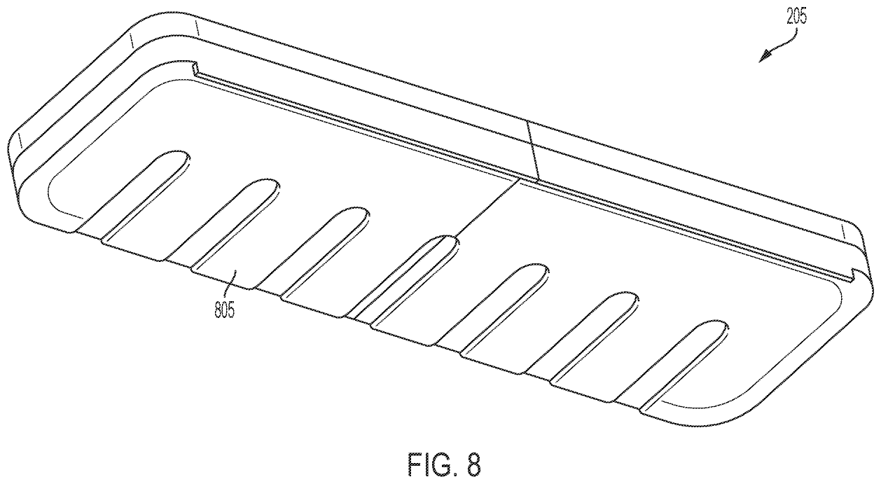

FIG. 8 depicts a bottom view of the apparatus 205, in accordance with an implementation. The apparatus 205 can include at least one enclosure 805. The enclosure 805 can enclose and insulate at least a portion of the apparatus 205. For example, the enclosure 805 can enclose the portion of the apparatus 205 shown in FIG. 7. The enclosure 805 can also insulate the apparatus 205 and provide a barrier between the apparatus 205 and the door 405.

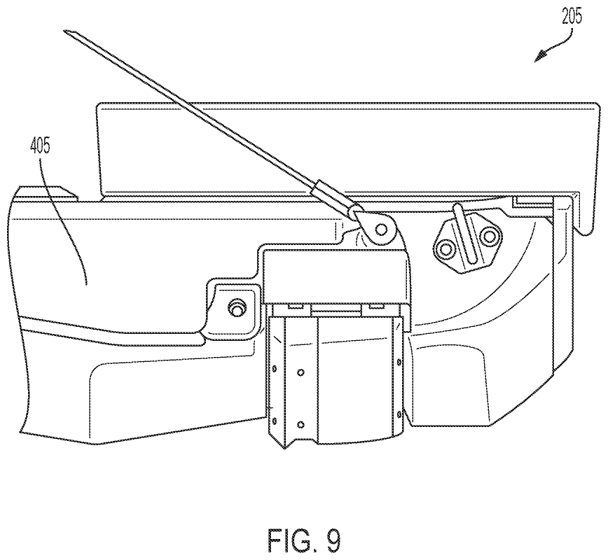

FIG. 9 depicts a side view of the vehicle 105 and the apparatus 205, in accordance with an implementation. The view of the vehicle 105 and the apparatus 205, depicted in FIG. 9, can be the view of the vehicle 105 and the apparatus 205, as shown in FIG. 4, including the portion of the vehicle 105 and the apparatus 205 that was previously removed and/or cutaway.

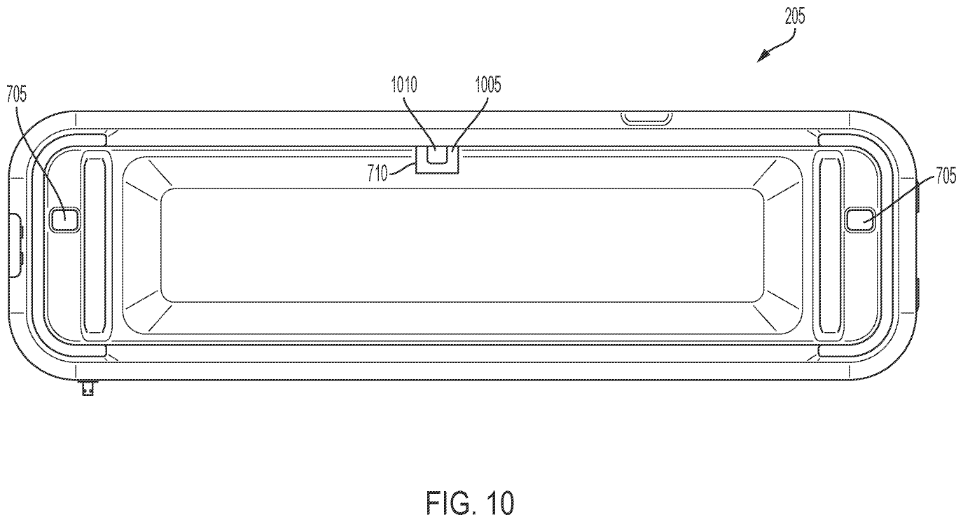

FIG. 10 depicts a bottom view of the apparatus 205, in accordance with an implementation. The supporting module 710 can include at least one first protrusion 1005 and at least one second protrusion 1010. The protrusion 1005 and the protrusion 1010 can make contact with the door 405. The protrusion 1005 and the protrusion 1010 can rotate, hinge, swivel or otherwise move from a position within the cooking module 210 to position external to the cooking module 210. The protrusion 1005 can have a first length and the protrusion 1010 can have a second length. The first length can be larger than, smaller than or equal to the second length. The second length can be larger than, smaller than or equal to the first length. FIG. 10 depicts an example of the protrusion 1005 located within the cooking module 210, and an example of the protrusion 1010 located within the cooking module 210.

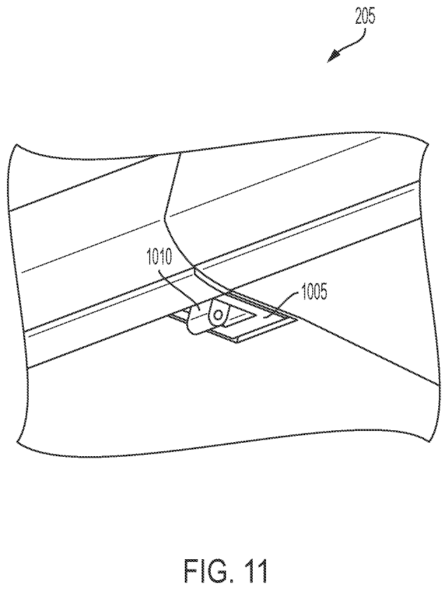

FIG. 11 depicts a bottom view of the apparatus 205, in accordance with an implementation. FIG. 11 depicts an example of the protrusion 1010 located in a position external to the cooking module 210 responsive to an operator of the apparatus 205 having moved the protrusion 1010 from within the cooking module 210 to the positon depicted in FIG. 11.

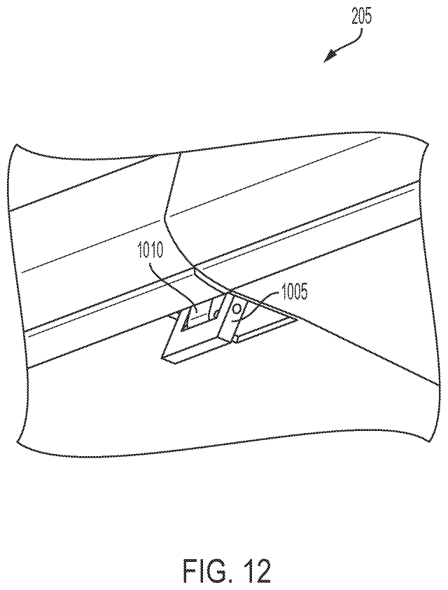

FIG. 12 depicts a bottom view of the apparatus 205, in accordance with an implementation. FIG. 12 depicts an example of the protrusion 1005 located in a position external to the cooking module 210 responsive to an operator of the apparatus 205 having moved the protrusion 1005 from within the cooking module 210 to the positon depicted in FIG. 12, and an example of the protrusion 1010 located in a position external to the cooking module 210 responsive to an operator of the apparatus 205 having moved the protrusion 1010 from within the cooking module 210 to the positon depicted in FIG. 12.

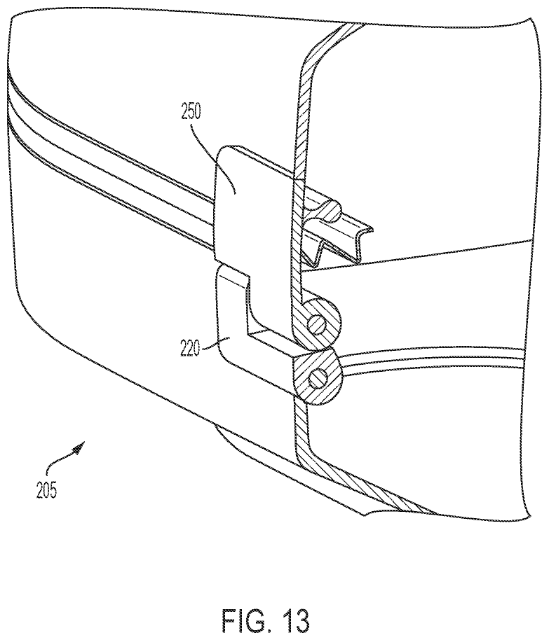

FIG. 13 depicts a side cross-sectional view of the apparatus 205, in accordance with an implementation. FIG. 13 depicts an example of the latch 220 engaging with the notch 250, and an example of the latch 220 coupling the heating surface 215 with the configurable surface 217.

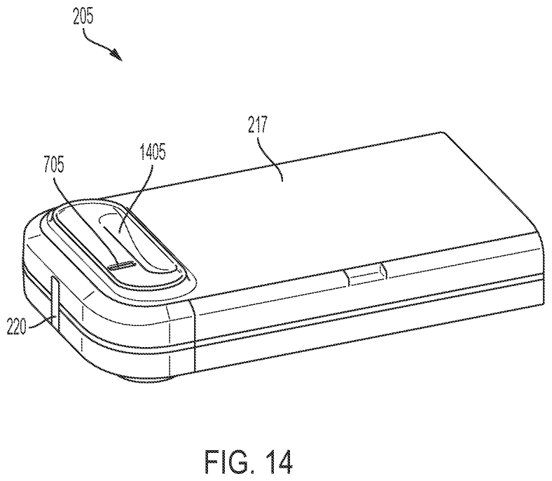

FIG. 14 depicts a top view of the apparatus 205, in accordance with an implementation. The apparatus 205 can include at least one indent 1405. The indent 1405 can be or include at least one of a handle, a slot, a recess or a contact point that the operator of the apparatus 205 can use to interact with, interface with, engage with or grab. For example, the operator of the apparatus 205 can grab the indent 1405 to assist in moving the apparatus 205 from the second configuration to the first configuration. FIG. 14 depicts an example of the apparatus 205 in the second configuration as the heating surface 215 has been folded over the configurable surface 217 and the configurable surface 217 has been folded over the heating surface 215.

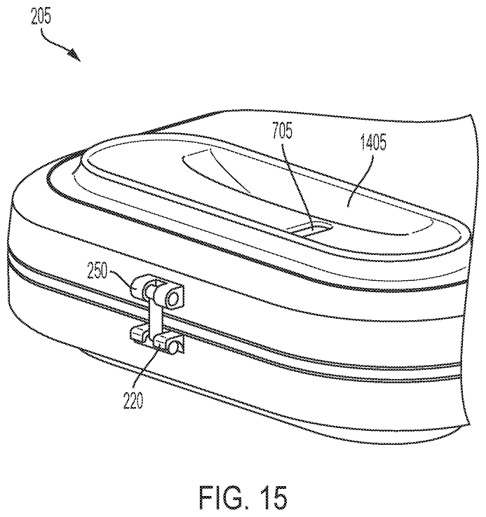

FIG. 15 depicts a side view of the apparatus 205, in accordance with an implementation. FIG. 15 depicts an example of the latch 220 as a recess that can receive the notch 250, an example of the apparatus 205 in the second configuration and an example of the configurable surface 217 coupled with the heating surface 215.

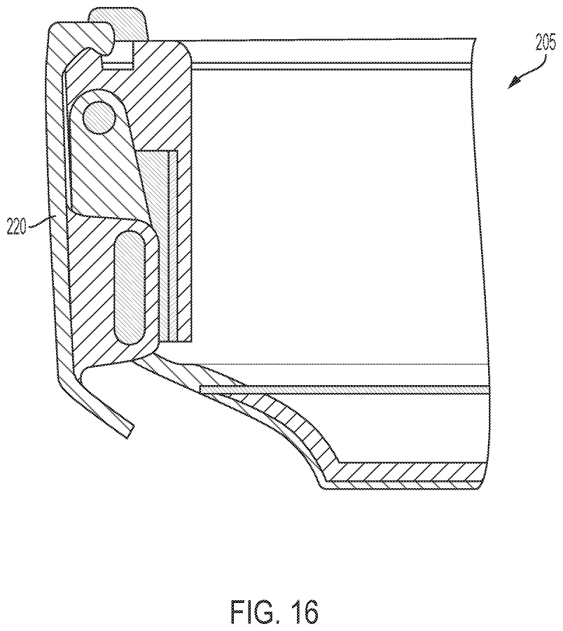

FIG. 16 depicts a cross-sectional view of the apparatus 205, in accordance with an implementation. FIG. 16 depicts an example of the apparatus 205 in the first configuration, and an example of the latch 220 having been decoupled from the notch 250 or an example of the latch 220 prior the latch 220 being coupled with the notch 250 (e.g., the resting position).

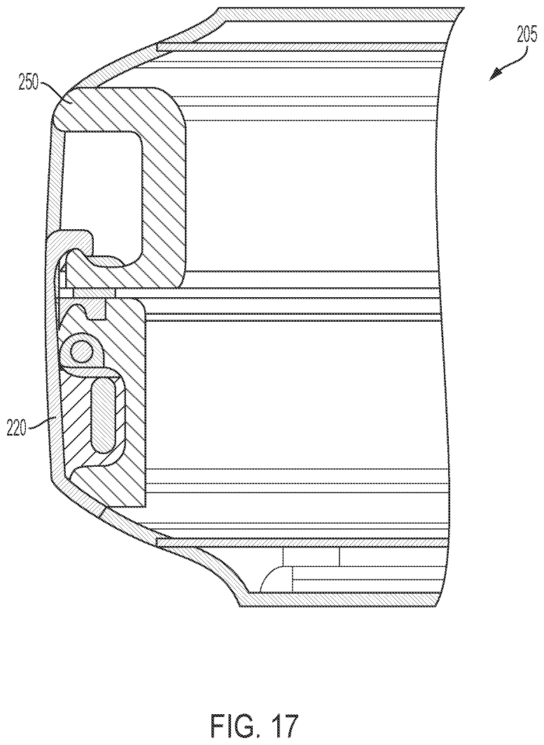

FIG. 17 depicts a cross-sectional view of the apparatus illustrated in FIG. 2, in accordance with an implementation. FIG. 17 depicts an example of the apparatus 205 in the first position, an example of the latch 220 being coupled with the notch 250 (e.g., the coupled position), and an example of the notch 250 being shaped to engage with the latch 220.

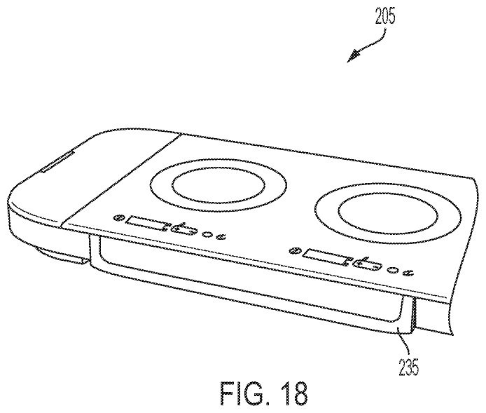

FIG. 18 depicts a top view of the apparatus 205, in accordance with an implementation. FIG. 18 depicts an example of the apparatus 205 in the first configuration, and an example of the handle 235 in the stowed position.

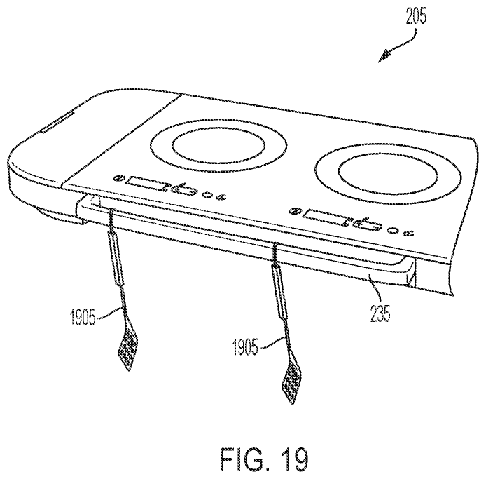

FIG. 19 depicts a top view of the apparatus 205, in accordance with an implementation. FIG. 19 depicts an example of the handle 235 in the deployed position, an example of the handle 235 supporting at least one component (e.g., components 1905), and an example of the component 1905 as spatulas. The handle 235 can be placed in the deployed responsive to the operator of the apparatus 205 grabbing the handle 235 and moving the handle 235 from the stowed position to the deployed position.

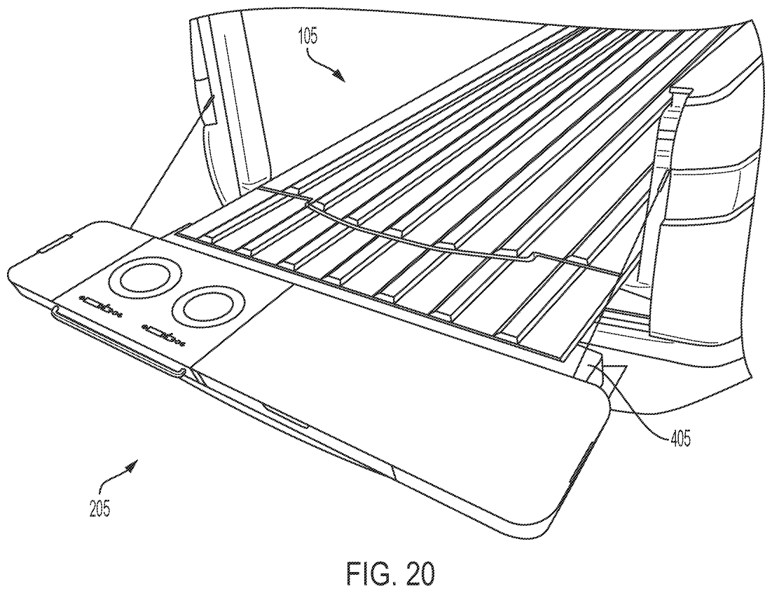

FIG. 20 depicts a rear view of the vehicle 105 including the apparatus 205, in accordance with an implementation. FIG. 20 depicts the vehicle 105 as a tuck, an example of the apparatus 205 coupled with the door 405, an example of the apparatus 205 in the first configuration, an example of the apparatus 205 coupled with the vehicle 105, and an example of the compartment 240 in the closed position. The apparatus 205 can be coupled with the vehicle 105 responsive to the hook 415 coupling with the latch 410.

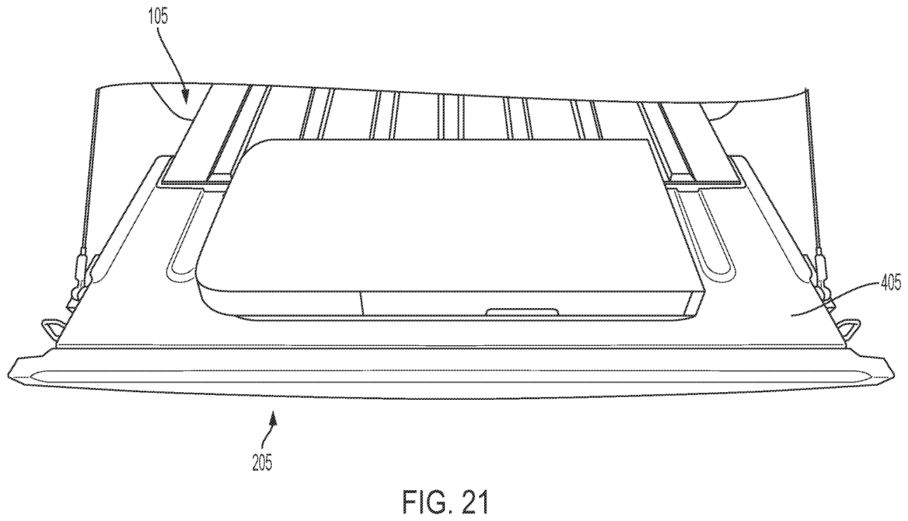

FIG. 21 depicts a rear view of the vehicle 105 including the apparatus 205, in accordance with an implementation. FIG. 21 depicts the vehicle 105 as a truck, an example of the apparatus 205 in the second configuration, an example of the apparatus 205 decoupled from the vehicle 105, and an example of the apparatus 205 resting on the door 405. The apparatus 205 can be decoupled from the vehicle 105 responsive to the hook 415 decoupling from the latch 410.

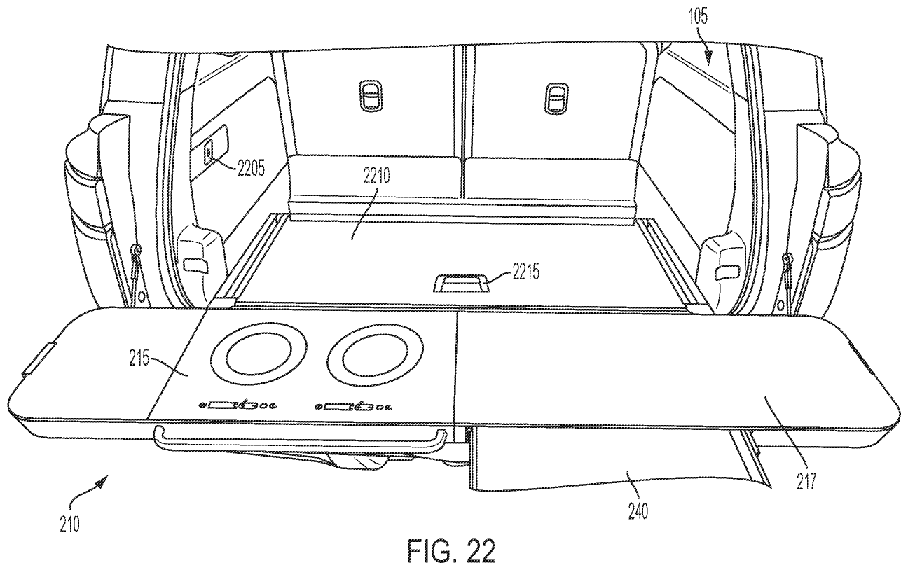

FIG. 22 depicts a rear view of a vehicle 105 including the apparatus 205, in accordance with an implementation. The vehicle 105 can include at least one outlet 2205, at least one lid 2210 and at least one handle 2215. The outlet 2205 can be electrically coupled with the battery 115. The apparatus 205 or a component thereof (e.g., the power cord 305) can be electrically coupled with outlet 2205. The apparatus 205 or a component thereof can be, responsive to being electrically coupled with the outlet 2205, electrically coupled with that battery 115. The lid 2210 can enclose at least one of a loadfloor, a subfloor compartment or a housing disposed partially between a portion of the vehicle 105 and a ground surface. For example, the lid 2210 can enclose and cover the loadfloor of the vehicle 105. The handle 2215 can be mounted, placed, secured, attached or otherwise coupled with the lid 2210. An operator of the vehicle 105 or the apparatus 205 can grab the handle 2215 to located, position, adjust or otherwise move the lid 2210.

FIG. 22 depicts the vehicle 105 as an SUV, an example of the apparatus 205 coupled with the door 405, an example of the door 405 as a liftgate of the vehicle 105, an example of the apparatus 205 in the first configuration, an example of the compartment 240 in the open position, and an example of the handle 235 in the deployed position. The compartment 240 can be placed in the open position responsive to an operator of the apparatus grabbing the handle 245 and moving the compartment 240 from the closed position to the open position.

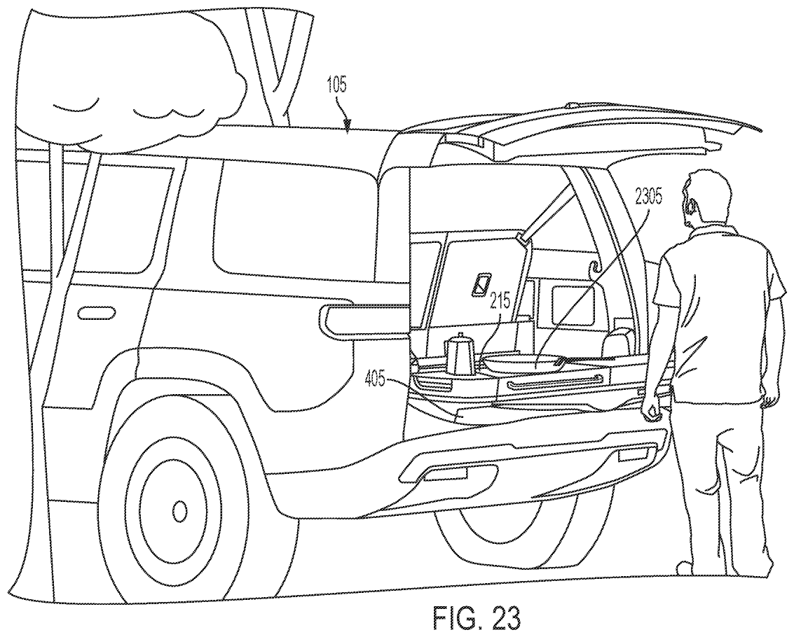

FIG. 23 depicts a rear view of the vehicle 105 including the apparatus 205, in accordance with an implementation. FIG. 23 depicts an example of the apparatus 205 coupled with the door 405, an example of the door 405 as a liftgate of the vehicle 105, an example of the heating surface 215 holding a component 2305, an example of the component 2305 as a pan, and an example of the heating element 225 heating the component 2305.

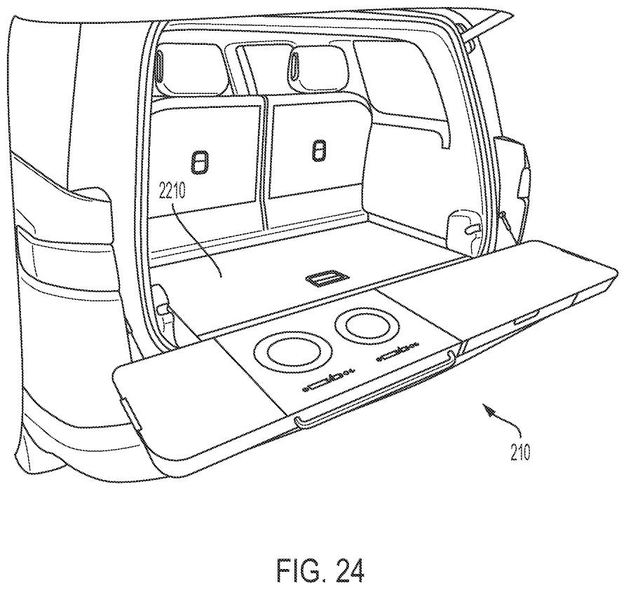

FIG. 24 depicts a rear view of the vehicle 105 including the apparatus 205, in accordance with an implementation. FIG. 24 depicts an example of the apparatus 205 coupled with the vehicle 105, an example of the cooking module 210 coupled with the vehicle 105, and an example of the lid 2210 enclosing the loadfloor of the vehicle 105.

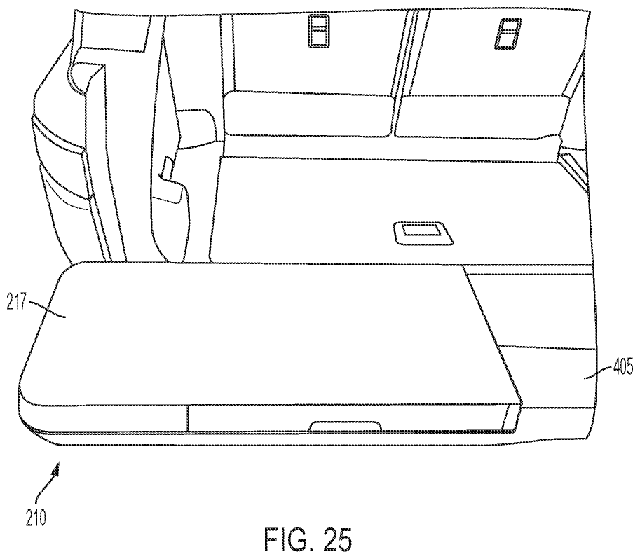

FIG. 25 depicts a rear view of the vehicle 105 including the apparatus 205, in accordance with an implementation. FIG. 25 depicts an example of the apparatus 205 decoupled from the vehicle 105, an example of the apparatus 205 in the second configuration, an example of the cooking module 210 decoupled from the vehicle 105, an example of the apparatus 205 resting on the door 405, and an example of the compartment 240 in the closed position.

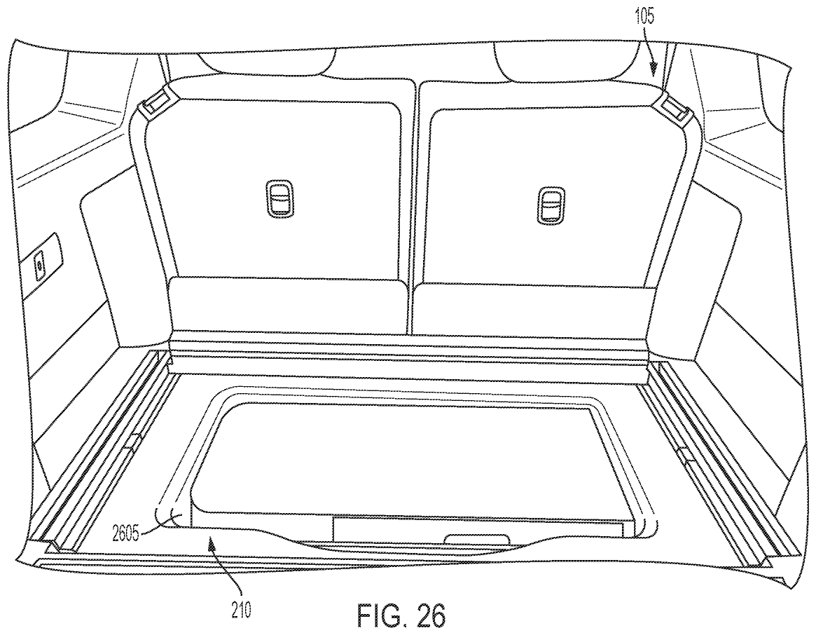

FIG. 26 depicts an internal view of the vehicle 105 including the apparatus 205, in accordance with an implementation. The vehicle 105 can include at least one loadfloor 2605. The loadfloor 2605 can be accessible responsive to an operator of the vehicle 105 or the apparatus 205 grabbing the handle 2215 and moving the lid 2210. The loadfloor 2605 can be shaped, designed, configured or otherwise formed to receive and hold the apparatus 205 with the apparatus 205 in the second configuration. FIG. 26 depicts an example of the apparatus 205 decoupled from the vehicle 105, an example of the apparatus 205 having been moved from the door 405 to an internal portion of the vehicle 105, an example of the apparatus 205 in the second configuration, and an example of the apparatus 205 stowed in the loadfloor 2605.

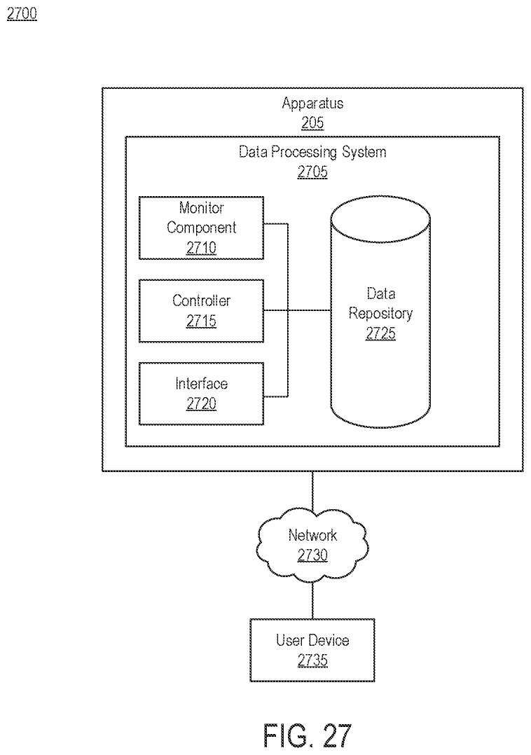

FIG. 27 depicts a system 2700 for controlling an apparatus. The apparatus can be the apparatus 205. The apparatus 205 can be included with the vehicle 105 or the apparatus 205 can be coupled with the vehicle 105. The system 2700 can include the apparatus 205, at least one network 2730 and at least one user device 2735. The apparatus 205 can include at least one data processing system 2705. The data processing system 2705 can include at least one monitor component 2710, at least one controller 2715, at least one interface 2720 and at least one data repository 2725. The data processing system 2705 or at least one component of the data processing system 2705 can be external to the apparatus 205. For example, the data processing system 2705 can be a remote server system (e.g., a cloud based data processing system) or a data processing system that is included in or stored on a user device (e.g., the user device 2735). Similarly, the data processing system 2705 can be included in the vehicle 105. For example, the data processing system 2705 can be included in an infotainment system of the vehicle 105.

The monitor component 2710 can be or include at least one motion sensor. The motion sensor can collect data. The motion sensor can collect data that can be used to determine at least one of a position or configuration of the apparatus 205 (e.g., first configuration or second configuration), a position of the latch 220 (e.g., resting position or coupled position) For example, the monitor component 2710 can determine that the apparatus 205 is in the first configuration.

The monitor component 2710 can be or include at least one interface sensor. The interface sensor can collect data that can be used to determine a selection on an interface. For example, the interface sensor can be a tactile sensor. The interface sensor can detect an operator of the apparatus 205 or the vehicle 105 selecting at least one option presented on a user interface. For example, an operator can select an option on a user interface, displayed by the interface 2720, to adjust the temperature of the heating surface 215 and the interface sensor can detect that the option to adjust the temperature of the heating surface 215 has been selected.

The interface 2720 can be or include at least one of a display device, a display screen, a monitor, an infotainment system of the vehicle 105 or a user device. The interface 2720 can display, provide, create, generate or otherwise present at least one user interface or at least one graphical user interface. The graphical user interface, presented by the interface 2720, can include at least one icon. For example, the interface can include an adjust temperature of the heating surface icon.

The data processing system 2705 and the user device 2735 can interface by using the network 2730. The user device 2735 can include at least one of a mobile phone, a smart watch, a tablet, a smart phone, an infotainment system of a vehicle (e.g., the infotainment system of the vehicle 105). An operator of the user device 2735 can perform similar operations to that performed by selecting icons on the interface 2720. For example, the user device 2735 can include an application that has been stored on the user device 2735 and is associated with the apparatus 205. For example, when an operator purchased the apparatus 205 or the vehicle 105 they received instructions of how to download the application and link the application with the apparatus 205 or the vehicle 105. An operator of the user device 2735 can select an icon on an interface of the user device 2735 to adjust the temperature of the heating surface 215.

The data repository 2725 can include, store, maintain or otherwise provide data. The data can be data that is collected and provided by the monitor component 2710, data that is collected and provided by the interface 2720 or data that is provided by the user device 2735.

The monitor component 2710 can detect, via the interface 2720, an indication to adjust the temperature of the heating surface 215. The indication can be an operator of the vehicle 105 or the apparatus 205 selecting an icon, displayed by the interface 27100, to adjust the temperature of the heating surface 215. For example, the monitor component 2710 can detect that an operator of the vehicle 105 has selected the icon to adjust the temperature of the heating surface 215.

The monitor component 2710 can, responsive to detecting the indication to adjust the temperature of the heating surface 215, communicate with, interface with or otherwise interact with the controller 2715. The monitor component 2710 can provide, to the controller 2715, the indication to adjust the temperature of the heating surface 215. The controller 2715 can be mounted, attached, placed, secured or coupled with the apparatus 205 or a component thereof. The controller 2715 can, responsive to receiving the indication to adjust the temperature of the heating surface 215, communicate with, interface with or otherwise interact with the adjusting module 230. For example, the controller 2715 can provide, to the adjusting module 230, a signal that causing the adjusting module 230 to adjust the amount of current that flows through the heating element 225. The adjusting module 230 can, responsive to indication, adjust the temperature of the heating surface 215.

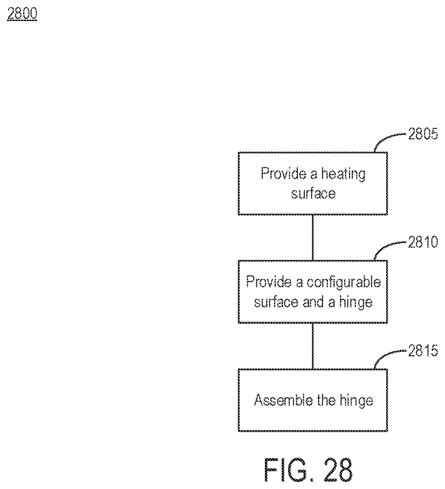

FIG. 28 is a flow diagram of a process 2800 of manufacturing an apparatus. The apparatus can be the apparatus 205. In ACT 2805, a heating surface can be provided. The heating surface can be the heating surface 215. The heating surface 215 can be provided during the manufacturing process of the vehicle 105 or the apparatus 205. The heating surface 215 can be provided by placing, positioning, coupling, or otherwise locating the heating surface 215 on or near the vehicle 105 or the apparatus 205. For example, the heating surface 215 can be placed on a tailgate (e.g., the door 405) of the vehicle 105. The heating surface 215 can be provided after the vehicle 105 has been purchased. For example, the heating surface 215 can be provided after the owner of the vehicle 105 purchases the heating surface 215 and the owner then takes the vehicle 105 to a shop that can then provide the heating surface 215. The owner of the vehicle 105 can provide the heating surface 215 on their own. For example, the owner of the vehicle 105 can provide the heating surface 215 upon purchasing the heating surface 215

In ACT 2810, a configurable surface and a hinge can be provided. The configurable surface can be the configurable surface 217 and the hinge can be the hinge 505. The configurable surface 217 and the hinge 505 can be providing to the vehicle 105 or the apparatus 205. The configurable surface 217 and the hinge 505 can be provided by placing, positioning, coupling, or otherwise locating the configurable surface 217 and the hinge 505 on or near the vehicle 105 or the apparatus 205. For example, the configurable surface 217 and the hinge 505 can be placed within the apparatus 205.

In ACT 2815, a hinge can be assembled. The hinge can be the hinge 505. The hinge 505 can be assembled to couple the heating surface 215 with the configurable surface 217. For example, the hinge 505 can be placed within the apparatus 205 and the hinge 505 can interface with, interact with or otherwise make contact with the heating surface 215 or the configurable surface 217. The hinge 505 can, responsive to making contact with the heating surface 215 and the configurable surface 217, mount, place, secure, attach or otherwise couple the heating surface 215 with the configurable surface 217. The hinge 505 can couple the heating surface 215 with the configurable surface 217 during at least one of the manufacturing process of the apparatus 205, when the apparatus 205 is provided to the vehicle 105 or when the apparatus 205 is provided to an operator or purchaser of the apparatus 205.

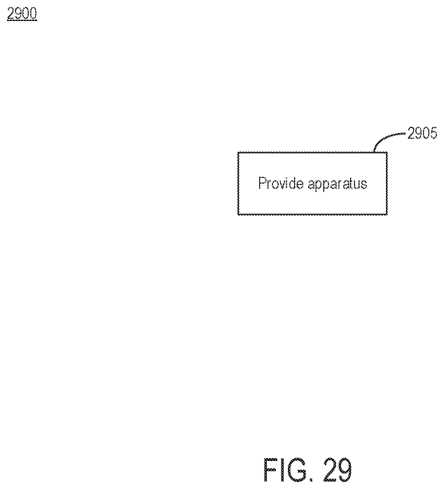

FIG. 29 is a flow diagram of a process 2900 where an apparatus can be provided. In ACT 2905, an apparatus can be provided. The apparatus can be the apparatus 205. The apparatus 205 can be provided to a vehicle (e.g., the vehicle 105). The apparatus 205 can be provided during the manufacturing process of the vehicle 105. The apparatus 205 can be provided after the vehicle 105 has been purchased. For example, the apparatus 205 can be provided after the owner of the vehicle 105 purchases the apparatus 205 and the owner then takes the vehicle 105 to a shop that can then provide the apparatus 205. The owner of the vehicle 105 can provide the apparatus 205 on their own. For example, the owner of the vehicle 105 can provide the apparatus 205 upon purchasing the apparatus 205. The apparatus 205 can include a heating surface (e.g., the heating surface 215), a configurable surface (e.g., the configurable surface 217), and a hinge (e.g., the hinge 505).

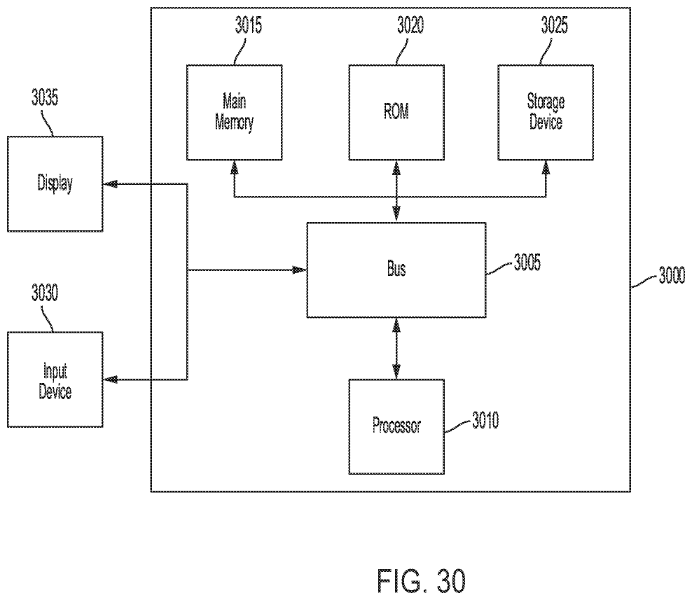

FIG. 30 depicts an example block diagram of an example computer system 3000. The computer system or computing device 3000 can include or be used to implement a data processing system or its components. The computing system 3000 includes at least one bus 3005 or other communication component for communicating information and at least one processor 3010 or processing circuit coupled to the bus 3005 for processing information. The computing system 3000 can also include one or more processors 3010 or processing circuits coupled to the bus for processing information. The computing system 3000 also includes at least one main memory 3015, such as a random access memory (RAM) or other dynamic storage device, coupled to the bus 3005 for storing information, and instructions to be executed by the processor 3010. The main memory 3015 can be used for storing information during execution of instructions by the processor 3010. The computing system 3000 may further include at least one read only memory (ROM) 3020 or other static storage device coupled to the bus 3005 for storing static information and instructions for the processor 3010. A storage device 3025, such as a solid state device, magnetic disk or optical disk, can be coupled to the bus 3005 to persistently store information and instructions.

The computing system 3000 may be coupled via the bus 3005 to a display 3035, such as a liquid crystal display, or active matrix display, for displaying information to a user such as a driver of the electric vehicle 105 or other end user. An input device 3030, such as a keyboard or voice interface may be coupled to the bus 3005 for communicating information and commands to the processor 3010. The input device 3030 can include a touch screen display 3035. The input device 3030 can also include a cursor control, such as a mouse, a trackball, or cursor direction keys, for communicating direction information and command selections to the processor 3010 and for controlling cursor movement on the display 3035.

The processes, systems and methods described herein can be implemented by the computing system 3000 in response to the processor 3010 executing an arrangement of instructions contained in main memory 3015. Such instructions can be read into main memory 3015 from another computer-readable medium, such as the storage device 3025. Execution of the arrangement of instructions contained in main memory 3015 causes the computing system 3000 to perform the illustrative processes described herein. One or more processors in a multi-processing arrangement may also be employed to execute the instructions contained in main memory 3015. Hard-wired circuitry can be used in place of or in combination with software instructions together with the systems and methods described herein. Systems and methods described herein are not limited to any specific combination of hardware circuitry and software.

Although an example computing system has been described in FIG. 30, the subject matter including the operations described in this specification can be implemented in other types of digital electronic circuitry, or in computer software, firmware, or hardware, including the structures disclosed in this specification and their structural equivalents, or in combinations of one or more of them.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. An apparatus, comprising:
a heating surface configured to electrically couple with a power source;
a configurable surface; and
a hinge coupled with the heating surface and the configurable surface.

2. The apparatus of claim 1, comprising:
the hinge configured to fold the heating surface with the configurable surface.

3. The apparatus of claim 1, comprising:
the power source including a battery of an electric vehicle;
a cooking module configured to couple with the electric vehicle and the cooking module configured to decouple from the electric vehicle, and the cooking module configured to electrically couple with the battery of the electric vehicle and the cooking module configured to electrically decouple from the battery of the electric vehicle;
the cooking module configured to house at least one of the heating surface or the configurable surface; and
the heating surface configured to operate with the cooking module decoupled from the electric vehicle.

4. The apparatus of claim 1, comprising:
a handle, coupled with the heating surface, the handle configured to adjust from a stowed position disposed within the heating surface to a deployed position disposed external to the heating surface; and
the handle configured to hold an object.

5. The apparatus of claim 1, comprising:
a supporting module configured to rest on a door of an electric vehicle; and
the supporting module configured to support at least a portion of the apparatus.

6. The apparatus of claim 1, comprising:
a latch configured to couple the heating surface with the configurable surface responsive to the hinge folding the heating surface with the configurable surface.

7. The apparatus of claim 1, comprising:
a compartment configured to store a component; and
the compartment including a railing, the railing configured to adjust the compartment from a first position to a second position,
wherein the compartment is disposed beneath the configurable surface with the compartment in the first positon and wherein at least a portion of the compartment extends beyond the configurable surface with the compartment in the second position;
wherein the component is accessible with the compartment in the second position.

8. The apparatus of claim 1, comprising:
the heating surface including:
a heating element configured to heat at least a portion of the heating surface;
an input device configured to adjust an amount of heat produced by the heating element; and
the input device including an optical indicator, the optical indicator configured to provide an indication of a temperature of the heating surface.

9. The apparatus of claim 1, comprising:
a hook, the hook configured to couple the apparatus with an electric vehicle responsive to the hook engaging with a latch of the electric vehicle; and
the latch disposed within a door of the electric vehicle.

10. The apparatus of claim 1, wherein the heating surface produces heat by at least one of induction heat, conduction heat, convection heat or radiant heat.

11. The apparatus of claim 1, comprising:
a data processing system, the data processing system comprising at least one processor, coupled with memory, to:
detect, via a graphical user interface, an indication to adjust a temperature of the heating surface; and
adjust, responsive to the indication, the temperature of the heating surface.

12. The apparatus of claim 1, comprising:
a first configuration, wherein the heating surface is accessible with the apparatus in the first configuration; and
a second configuration, wherein the apparatus is placed in the second configuration responsive to the hinge folding the heating surface with the configurable surface; and
the apparatus configured to stow in a vehicle with the apparatus in the second configuration.

13. An electric vehicle, comprising:
a heating surface configured to electrically couple with a battery of the electric vehicle;
a configurable surface, and
a hinge coupled with the heating surface and the configurable surface.

14. The electric vehicle of claim 13, comprising:
the hinge configured to fold the heating surface with the configurable surface.

15. The electric vehicle of claim 13, comprising:
a cooking module configured to couple with the electric vehicle and the cooking module configured to decouple from the electric vehicle, and the cooking module configured to electrically couple with the battery of the electric vehicle and the cooking module configured to electrically decouple from the battery of the electric vehicle;
the cooking module configured to house at least one of the heating surface of the configurable surface; and
the heating surface configured to operate with the cooking module decoupled from the electric vehicle.

16. The electric vehicle of claim 13, comprising:
a supporting module configured to rest on a door of the electric vehicle; and
the supporting module configured to support at least a portion of the heating surface.

17. The electric vehicle of claim 13, comprising:
the heating surface including:
a heating element configured to heat at least a portion of the heating surface;
an input device configured to adjust an amount of heat produced by the heating element; and
the input device including an optical indicator, the optical indicator configured to provide an indication of a temperature of the heating surface.

18. The electric vehicle of claim 13, comprising:
a data processing system, the data processing system comprising at least one processor, coupled with memory, to:
detect, via a graphical user interface, an indication to adjust a temperature of the heating surface; and
adjust, responsive to the indication, the temperature of the heating surface.

19. A method, comprising:
providing a heating surface, the heating surface configured to electrically couple with a power source;
providing a configurable surface and a hinge; and
assembling the hinge to couple with the heating surface and the configurable surface.

20. The method of claim 19, comprising:
coupling a cooking module with an electric vehicle, the cooking module configured to decouple from the electric vehicle; and
wherein the cooking module is configured to house at least one of the heating surface or the configurable surface
wherein the heating surface is configured to operate with the cooking module decoupled from the electric vehicle.
